(19) United States
(12) Patent Application Publication
(10) Pub. No.: US 2023/0116663 A1
(43) Pub. Date: Apr. 13, 2023

(54) Sensor Device for a Mouth-Nose Protection and Mouth-Nose Protection Device

(71) Applicant: TDK Electronics AG, Munich (DE)

(72) Inventors: Dr. Bernhard Ostrick, Teltow (DE); Dr. Wolfgang Schreiber-Prillwitz, Fröndenberg (DE); Dr. Waldemar Unrau, Berlin (DE); Axel Pecina, St. Martin (AT); Masahiro Oishi, Kawasaki-shi (JP); Masayuki Muroi, Deutschlandsberg (AT); Dr. Yongli Wang, Frauental (AT)

(21) Appl. No.: 17/905,610

(22) PCT Filed: May 6, 2021
(86) PCT No.: PCT/EP2021/062035

§ 371 Date: Sep. 2, 2022

(30) Foreign Application Priority Data
May 7, 2020 (DE) 10 2020 112 448.1
May 7, 2020 (DE) 10 2020 112 450.3

(51) Int. Cl. A62B 9/00; A62B 18/08; A62B 23/02

(52) U.S. Cl. CPC A62B 9/006; A62B 18/08; A62B 23/025; H02J 50/001

(57) ABSTRACT

In an embodiment a sensor device for arrangement on a mouth-nose protection includes a sensor unit having at least one sensor element configured to detect individual breathing processes of a user when the mouth-nose protection with the sensor device is used by a user and an evaluation unit configured to count the breathing processes of the user depending on a detection signal provided by the sensor unit and provide an evaluation signal for a signaling unit depending on a determined number of breathing processes.

This patent application is a national phase filing under section 371 of PCT/EP2021/062035, filed May 6, 2021, which claims the priority of German patent application 102020112450.3, filed May 7, 2020, and German patent application 102020112448.1, filed on May 7, 2020, each of which is incorporated herein by reference in its entirety.

### TECHNICAL FIELD

The invention relates to a sensor device for a mouth-nose protection and a mouth-nose protection device comprising the sensor device.

### BACKGROUND

Medical face half-masks or makeshift mouth-nose masks, also called everyday masks, are an aid to reduce transmission of pathogens to others through secretion droplets. Such masks lose their effect with a soaking of the mask. For medical masks, for example, there is a recommendation that they should be disposed of and replaced after each use if possible, but in case of need for multiple use after a maximum of eight hours or as soon as they have become damp. For makeshift mouth-nose masks, there is the recommendation that they should be discarded and replaced as soon as they have become damp and should be replaced after a maximum of one day. Since it is difficult for a user of a medical face half mask or makeshift mouth-nose mask to assess the moisture of the medical face half mask or makeshift mouth-nose mask, the user only has a specific recommendation after which time the mask should be changed. However, masks that are changed too frequently represent a cost factor and pollute the environment. Masks that are changed too infrequently, on the other hand, represent a health risk.

### SUMMARY

Embodiments provide a sensor device and a mouth-nose protection device that provide an indication for changing a mouth-nose protection device according to need.

According to a first aspect, by a sensor device for arrangement on a mouth-nose protection is discussed. Here, the mouth-nose protection is configured as a face half mask and comprises one or more paper layers and/or one or more fabric layers for covering a mouth-nose region of a user. The sensor device comprises a sensor unit having at least one sensor element. The sensor unit is adapted to detect individual breathing processes of the user when the mouth-nose protection is used together with the sensor device by a user. Furthermore, the sensor device comprises an evaluation unit. The evaluation unit comprises a counter and is adapted to count the breathing processes of the user depending on a detection signal provided by the sensor unit. The evaluation unit is further adapted to provide an evaluation signal for a signaling unit depending on a determined number of breathing processes.

Mouth-nose protection is understood to mean face half-masks which have one or more paper layers and/or one or more fleece layers and/or one or more fabric layers for covering a mouth-nose region, which are fixed to the back of the head or behind the ears of the user by means of binding or elastic bands.

These include, in particular, medical face half masks, makeshift mouth-nose masks and particle filtering half masks (Filtering Face Piece).

Medical face half masks are also called surgical masks, medical face masks, clinic masks, operating room face masks or hygiene masks. The makeshift mouth-nose masks are also called community mask, mouth-nose covering, everyday mask or makeshift mask. The particle filtering half masks are also called fine dust mask, dust mask, respirator or FFP mask. Depending on the design, the particle-filtering half masks protect against the inhalation of particles and aqueous or oily aerosols.

The sensor device allows to count the user's breaths into the mouth-nose protection when using the mouth-nose protection together with the sensor device and to indicate a need to change the mask after a certain number of breaths. Here, using the mouth-nose protection is understood to mean wearing the mouth-nose protection over the nose and mouth.

The sensor unit is arranged to detect a signal comprising the user's breathing rate. A breathing process preferably comprises a single inhalation or a single exhalation or a single breathing cycle.

In an advantageous embodiment according to the first aspect, the at least one sensor element of the sensor unit is configured as a temperature sensor element or a humidity sensor element or a pressure sensor element or carbon dioxide gas sensor element or a sound transducer sensor element.

The temperature sensor element is preferably configured to provide a sensor signal representative of a temperature of an air located between a facial surface in the mouth-nose region of the user and the mouth-nose protection. The temperature sensor element enables temperature differences of an inhaled air and exhaled air to be detected and subsequently evaluated.

The humidity sensor element is preferably adapted to provide a sensor signal representative of a humidity of the air located between a facial surface in the user's mouth-nose region and the mouth-nose protection. The humidity sensor element enables humidity differences in the inhaled and exhaled air to be detected and subsequently evaluated.

The pressure sensor element is preferably adapted to provide a sensor signal representative of an air pressure of air located between a facial surface in the user's mouth-nose region and the mouth-nose protection. The pressure sensing element enables pressure differences of the inhaled and exhaled air to be detected and subsequently evaluated.

The carbon dioxide gas sensor element is preferably adapted to provide a sensor signal representative of a carbon dioxide concentration of air located between a facial surface in the user's mouth-nose region and the protective element of the mouth-nose protection. The carbon dioxide gas sensor element enables carbon dioxide concentration differences in the inhaled and exhaled air to be detected and subsequently evaluated.

The sound transducer sensor element, which may also be referred to as a microphone, is preferably adapted to provide a sensor signal representative of a breath intake sound and/or breath expulsion sound of the user of the mouth-nose protection device.

In a further advantageous embodiment according to the first aspect, the at least one sensor element of the sensor unit is configured as a thermal conductivity sensor element. The thermal conductivity sensor element is preferably configured to provide a sensor signal representative of a thermal conductivity of air located between a facial surface in the mouth-nose region of the user and the protective element of the mouth-nose protection. The thermal conductivity sensor element enables thermal conductivity differences in the inhaled and exhaled air to be detected and subsequently evaluated.

The sensor unit can have a single sensor element or several, in particular several different, sensor elements that provide corresponding sensor signals. Evaluating multiple sensor signals allows to use a correlated occurrence of the corresponding sensor signals to make the counting of breathing processes more robust to environmental influences.

In another advantageous embodiment according to the first aspect, the sensor device has a separating element or a separating element is assigned to the sensor device, wherein the separating element is arranged and configured to separate the sensor element from a skin of the user. The separating element is formed, for example, from a layer of the mask fabric. In this case, the sensor element or the sensor device may be arranged, for example, on a side of the mask facing away from the face of the user or in an intermediate layer. Alternatively, the sensor device has a housing or encapsulation that at least partially encloses at least part of the sensor device, but at least the sensor element, and thus protects it from dirt and damage. Here, the separating element is part of the housing or encapsulation and forms an outer surface of the housing or encapsulation. In this case, the housing or encapsulation is arranged together with the at least one part of the sensor device, for example, on a side of the mouth-nose protection that is directed towards the face of the user. Preferably, the housing or the encapsulation is arranged in such a way that the outer surface formed by the separating element faces towards the face of the user.

In a further advantageous embodiment according to the first aspect, the separating element comprises at least one opening for a gas or air supply to the at least one sensor element. The at least one opening allows for sufficient gas transport.

In a further advantageous embodiment according to the first aspect, the separating element comprises a perforation for a gas or air supply to the at least one sensor element. A special design of the regular arrangement, amount, shape and size of the holes of the perforation allow for improved gas transport.

In a further advantageous embodiment according to the first aspect, the sensor unit comprises a differentiator having an input electrically coupled to an output of the at least one sensor element for receiving a sensor signal of the at least one sensor element. The differentiator is adapted to provide an output signal representing or approximating a first derivative of the sensor signal provided by the at least one sensor element. Preferably, the differentiator comprises a differentiator amplifier or the differentiator is configured as a differentiator amplifier. The differentiator has the advantage that the breathing processes can be reliably detected.

In a further advantageous embodiment according to the first aspect, the sensor unit comprises a data slicer having an input electrically coupled to an output of the at least one sensor element for receiving a sensor signal of the at least one sensor element. The data slicer is configured to equate the sensor signal to a floating reference, wherein the floating reference is derived or determined from an average DC value of the sensor signal. The data slicer has the advantage that the breathing processes can be detected reliably and in a power-saving manner.

In a further advantageous embodiment according to the first aspect, the at least one sensor element is arranged spatially separated from the evaluation unit and/or the signaling unit and/or further components of the sensor unit and/or a power supply on the mouth-nose protection. The spatially separated arrangement has the advantage that measurement-sensitive elements or units can be optimally positioned in terms of measurement, while non-measurement-sensitive elements can be positioned in peripheral areas in which they do not disturb a user.

In a further advantageous embodiment according to the first aspect, the mouth-nose protection comprises a predetermined or determined mask area and at least the one sensor element is arranged at a position within the mask area such that a ratio between a first distance from a center of the mask area to the position of the sensor element and a second distance from a mask edge to the position of the sensor element has a value less than or equal to four. This has the advantage that breathing processes can be detected more reliably.

In a further advantageous embodiment according to the first aspect, the sensor device comprises at least one connecting device for a releasable mechanical coupling of the sensor device or at least a part of the sensor device to the mouth-nose protection.

For example, the connecting device comprises a clamp and/or a clip and/or a retaining clip and/or a magnetic fastener. In an alternative embodiment, the sensor device or a portion of the sensor device is mechanically fixedly coupled to the mouth-nose protection.

In a further advantageous embodiment according to the first aspect, the sensor device comprises the signaling unit and the signaling unit is adapted to output an optic and/or acoustic and/or haptic signal depending on the evaluation signal provided by the evaluation unit.

In a further advantageous embodiment according to the first aspect, the evaluation unit comprises a wireless interface for wireless transmission of the evaluation signal to a predetermined terminal device. Use of an assigned signaling device has the advantage that installation space can be saved in the sensor device. Furthermore, signaling of a mask state can be kept secret more easily.

In a further advantageous embodiment according to the first aspect, the sensor device comprises a power supply unit comprising an accumulator, which is designed as a solid state accumulator.

In a further advantageous embodiment according to the first aspect, the sensor device comprises a charging unit for charging the accumulator.

In a further advantageous embodiment according to the second aspect, the charging unit comprises a passive charging port and/or an energy harvesting unit.

In accordance with a second aspect, the a mouth-nose protection device comprising a mouth-nose protection configured as a face half-mask and comprising one or more paper layers and/or one or more fabric layers for covering a mouth-nose region of a user, and a sensor device in accordance with the first aspect is discussed. The sensor device is arranged on the mouth-nose protection. Advantageous embodiments of the sensor device according to the first aspect are also applicable to the mouth-nose protection device according to the second aspect.

### BRIEF DESCRIPTION OF THE DRAWINGS

Examples of embodiments of the invention are explained below with reference to the schematic drawings.

FIG. 1 shows an exemplary embodiment of a mouth-nose protection device;

FIG. 2 shows a schematic block diagram of a monitoring module for the mouth-nose protection device;

FIG. 3 shows a further exemplary embodiment of a mouth-nose-protection device;

FIG. 4 shows an exemplary electrical equivalent circuit diagram of a sensor device;

FIG. 5 shows an exemplary electrical equivalent circuit diagram of a detection unit of the sensor device;

FIG. 6 shows an exemplary electrical equivalent circuit diagram of a further detection unit of the sensor device;

FIG. 7 shows a further exemplary electrical equivalent circuit diagram of a detection unit of the sensor device;

FIG. 8 shows an exemplary course of the sensor signal;

FIG. 9 shows a voltage curve at the output of the detection unit shown in FIG. 7; and

FIG. 10 shows a mouth-nose protection with an exemplary arrangement of the sensor device.

### DETAILED DESCRIPTION OF ILLUSTRATIVE EMBODIMENTS

Elements of the same design or function are marked with the same reference signs across the figures.

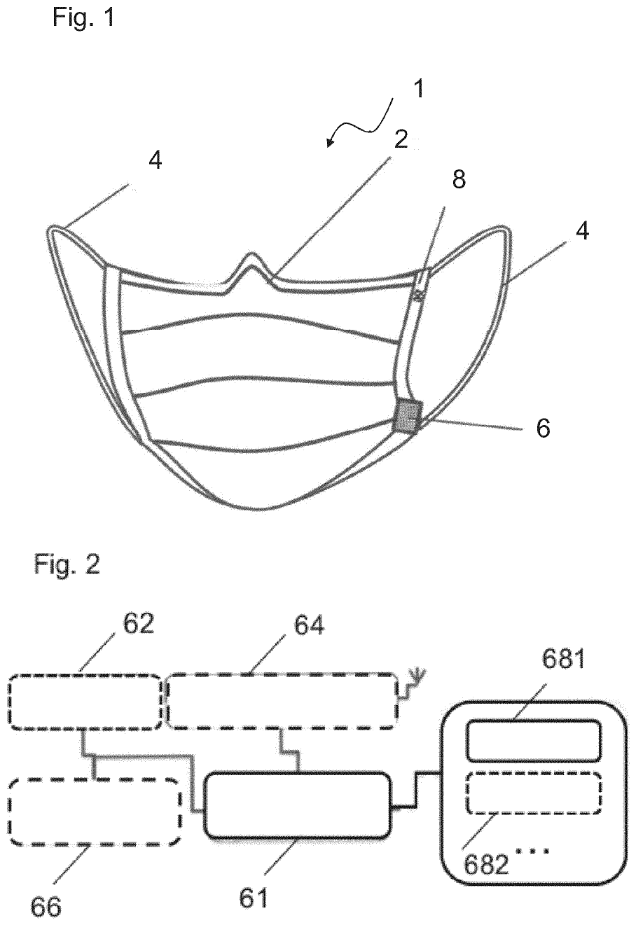

FIG. 1 shows an exemplary embodiment of a mouth-nose protection device 1. The mouth-nose protection device 1 comprises a mouth-nose protection and a sensor device 6. The sensor device 6 may also be referred to as a monitoring module.

Optionally, the mouth-nose protection device 1 has a strip code and/or quick response (QR) code 8.

The QR code 8 or bar code shown in FIG. 1 can be used, for example, to facilitate initialization and activation of the sensor device. For example, the QR code 8 may include specification data of the mouth-nose protection and/or a product identification so that a connection setup can be initiated by scanning the code.

For example, the mouth-nose protection is a medical face half mask. Alternatively, the mouth-nose protection is a makeshift mouth-nose mask or a particle-filtering face half mask. A makeshift mouth-nose mask is a tailored piece of fabric worn over the chin, mouth, and nose. It is usually made of cotton fabric sewn into pleats or tailored to fit the shape of the face.

The mouth-nose protection in FIG. 1 has a protective element 2 and one or more binding bands or one or more flexible bands, for example elastic bands 4. The protective element 2 has one or more paper layers and/or one or more fleece layers and/or one or more fabric layers and is used to cover a mouth and nose of a user. The bands allow the protective element 2 to be held in the mouth-nose region. For example, the bands are fixed to the back of the head or behind the ears.

Preferably, the protective element 2 is configured to cover the nose, the mouth and a chin of a user.

FIG. 2 shows a schematic block diagram of a sensor device 6 for the mouth-nose protection device.

For example, the sensor device 6 comprises a power supply unit 61 including a solid state accumulator.

In an optional embodiment, the sensor device 6 comprises a calculation unit 62. The sensor device 6 additionally comprises, for example, a wireless communication interface 64 and/or a charging unit 66.

For example, the calculation unit 62 comprises a microprocessor or a microcontroller. For example, the calculation unit 62 comprises a timer and/or a counter.

The calculation unit 62 is configured, for example, depending on a provided activation signal, to activate the timer and, when the timer exceeds a predetermined time limit, to generate and provide a first reminder signal. Alternatively or additionally, the calculation unit is configured, for example, depending on a provided count signal, to increment the counter and, when the counter exceeds a predetermined number, to generate a second reminder signal.

The wireless communication interface 64 comprises, for example, a Bluetooth interface and/or an infrared interface and/or an ultrasonic interface. For example, the calculation unit is adapted to control a communication via the wireless communication interface 64. The monitoring module 6 is thus configured, for example, to communicate with a particular terminal device, for example, a smartphone, an information center, etc., and to send reminder signals and/or reminder messages to the terminal device. For example, the monitoring module 6 is adapted to connect to the terminal device, referred to in English as pairing. This pairing can be used to generate the activation signal for the timer.

In the embodiment of the sensor device shown in FIG. 2, the power supply unit 6i comprises, for example, an accumulator. The accumulator is formed as a solid-state accumulator, for example. In addition, the power supply unit can have a charging interface for inductive or wired charging of the accumulator.

The battery or the accumulator is preferably designed as a miniaturized component, for example as a surface-mounted device.

The charging unit is used to charge the accumulator. The charging unit comprises, for example, a passive charging port. The passive charging port may, for example, be arranged for connection of a universal serial bus cable, or may comprise a wireless charging foil and/or a power converter. Alternatively or additionally, the charging unit comprises, for example, an energy harvesting unit.

The accumulator is preferably implemented as a surface-mounted component.

The sensor device preferably comprises a single printed circuit board on which all electronic and electrical components of the sensor device are arranged. Preferably, the sensor device 6 comprises a housing or encapsulation. In particular, the housing may be formed by a fluid-tight potting compound.

The sensor device comprises, for example, a connecting element that provides a releasable mechanical coupling of the sensor device 6 to the mouth-nose protection. The connecting device comprises, for example, a clamp and/or a clip and/or a retaining clip and/or a magnetic fastener.

For example, the sensor device 6 is formed as a single unit. Alternatively, it is possible, as shown in FIG. 3, that the sensor device 6 comprises several parts 6a, 6b and is arranged in a distributed manner on the mouth-nose protection, with one part 6b being arranged in an edge area 9.

The spatially separated arrangement has the advantage that measurement-sensitive elements or units can be optimally positioned in terms of measurement, while non-measurement-sensitive elements can be positioned in edge areas 9 in which they do not disturb a user.

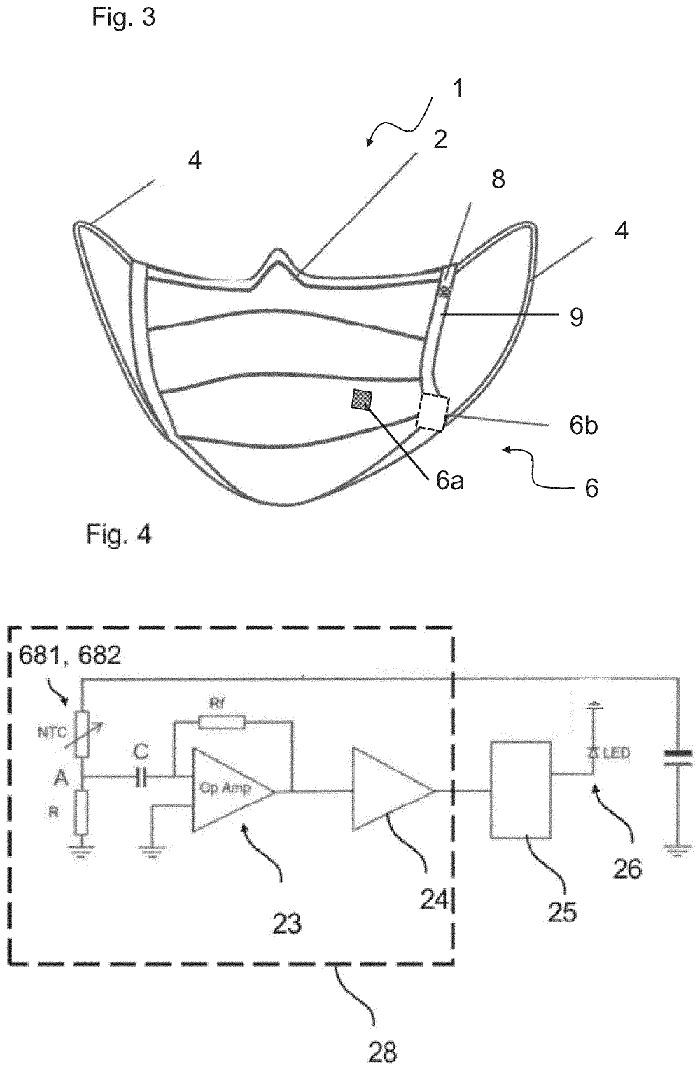

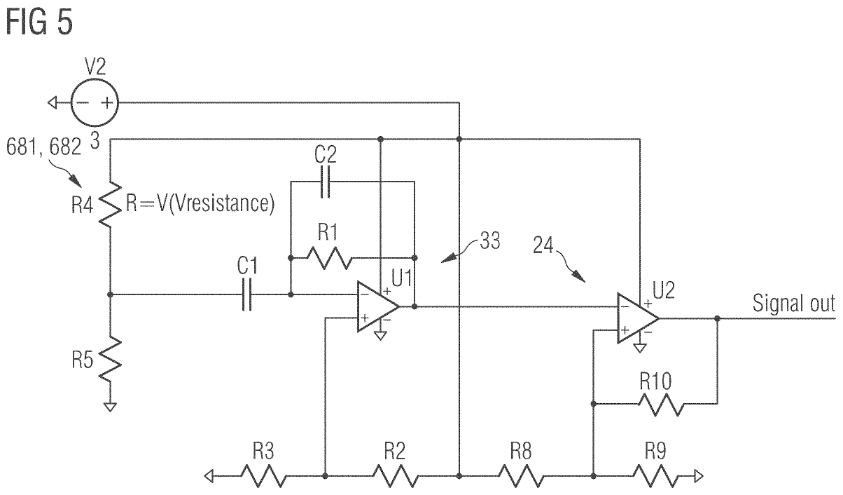

The sensor device 6 has, as shown by way of example in FIG. 4, a sensor unit 28 and an evaluation unit 25. The sensor device 6 further comprises, for example, a signaling unit 26.

The sensor device 6 further comprises, for example, a separating element (not shown in FIG. 4) or a separating element is assigned to the sensor device 6, wherein the separating element is arranged and configured to separate a sensor element 681, 682 of the sensor device 6 from a skin of the user. The separating element is formed, for example, from a layer of the mask fabric.

Alternatively, the sensor device 6 has a housing or encapsulation that at least partially encloses at least a portion of the sensor device 6, but at least encloses the sensor element 681, 682, thereby protecting it from dirt and damage. Here, for example, the separating element is part of the housing or the encapsulation and forms an outer surface of the housing or the encapsulation. The housing or the encapsulation is arranged here together with the at least one part of the sensor device 6, for example, on a side of the mouth-nose protection that is directed towards the face of the user. Preferably, the housing or the encapsulation is arranged in such a way that the outer surface formed by the separating element faces towards the face of the user.

The separating element comprises, for example, at least one opening or perforation for a gas or air supply to the at least one sensor element.

The sensor device 6, when the separating element is formed from the layer of mask fabric, may have a housing or partial encapsulation.

FIG. 4 shows an exemplary electrical equivalent circuit diagram of the sensor device 6.

The sensor unit 28 of the sensor device 6 is arranged to detect a breath and/or a breath expulsion of a user of the mouth-nose-protection device. For this purpose, the sensor unit 28 comprises a sensor element 681,682 and a detection unit comprising, for example, a differentiator 23 and a decider circuit 24.

Alternatively, the sensor device 6 may comprise more than one sensor element 681,682, in particular also different sensor elements 681,682 for different measured variables. For example, the sensor device 6 may comprise a temperature sensor element and/or a pressure sensor element and/or humidity sensor element and/or carbon dioxide gas sensor element and/or a sound transducer sensor element.

Advantageously, a thermal conductivity sensor element can also be used, with the aid of which a thermal conductivity of the air can be detected, since humidity and CO₂ occur together during exhalation and both gases reduce the thermal conductivity of the air. Such an arrangement includes, for example, two heated temperature sensors, one of which is encapsulated from the environment and one of which is in contact with the ambient air.

The sensor element 681, 682 according to FIG. 4 is, for example, a temperature sensor element. The temperature sensor element comprises, for example, a thermistor, also abbreviated to NTC thermistor (Negative Temperature Coefficient Thermistor).

The temperature sensor element is preferably adapted to provide a sensor signal representative of a temperature of an air located between a facial surface in the mouth-nose region of the user and the mouth-nose protection.

For example, the temperature sensing element is adapted for the measurement range between 0° C. and 30° C. In this case, the sensor device 6 is designed, for example, to use temperature changes in the range greater than 1K/sec as a trigger for counting an exhalation pulse and/or to use a temperature change in the range greater than −0.5K/sec as a trigger for counting an inhalation pulse.

For example, when using a humidity sensor element, the sensor device 6 is configured to use humidity increases to above 28.8 g/m3 (corresponding to 95% relative humidity at 30° C., for example) as a trigger for the breathing process and/or to use humidity decreases from at least approximately 28 g/m3 (corresponding to 92.2% relative humidity at 30° C.) to at least approximately below 26 g/m3 (corresponding to 85.7% relative humidity at 30° C., for example) as a trigger for a breathing process.

For example, when using a carbon dioxide gas sensing element, the sensing device 6 is configured to use increases in CO₂ to above 2% as a trigger for a breathing process, or alternatively or additionally to use rates of change in CO₂ concentration of above 0.25%/sec as a trigger for a breathing process. Alternatively or additionally, the sensor device 6 is configured, for example, to use CO₂ drops from above 2% to below 1% as a trigger for the breathing process, or alternatively or additionally to use rates of change in CO₂ concentration of below −0.25%/sec as a trigger for a breathing process.

The sensor element 681,682 provides a sensor signal at its output. In the embodiment shown in FIG. 4, the NTC thermistor together with another ohmic resistor forms a voltage divider. The voltage divider is connected, for example, between the power supply and a reference potential, preferably ground. The sensor signal is tapped, for example, at a node A between the ohmic resistor and the NTC thermistor.

The temperature sensor element is adapted to detect temperature differences of the inhaled and exhaled air. When the user exhales, for example, the NTC thermistor heats up and the resistance of the NTC thermistor changes. As a result, a voltage at node A changes.

The sensor signal is supplied to the detection unit.

The output of the sensing element, exemplified by node A of the voltage divider in FIG. 4, is coupled to an input of a differentiator 23. The differentiator 23 comprises, for example, a differentiator amplifier.

Preferably, the differentiator amplifier comprises an operational amplifier. A first input of the operational amplifier is electrically coupled to a reference potential, for example ground. The differentiator amplifier comprises a resistive feedback resistor connected between an output of the operational amplifier and a second input of the operational amplifier. The differentiator amplifier has a capacitance connected between the input of the differentiator 23 and the input of the operational amplifier.

The voltage change in node A is passed through the capacitor to the second input of the operational amplifier. By interposing the capacitor, the actual voltage variation at the node is not passed to the operational amplifier, but only the change in voltage.

The differentiator amplifier thus has the advantage that no basic setting of a zero point or adjustment of the operational amplifier is required. A dimensioning of the capacitor and the feedback resistor substantially determines or influences a sensitivity of the differentiator 23 and can be adapted to application requirements.

For example, an output of the differentiator 23 is electrically coupled to the decider circuit 24. The decider circuit 24 includes, for example, a threshold decider, a comparator, or a Schmitt trigger.

As described above, an exhalation of the user causes the voltage at node A to change. An output signal is available at the output of the differentiator 23 that at least approximately represents a first derivative of the voltage profile at node A. For example, the decider circuit 24 is arranged to output a signal representing a first binary value, for example the value 1, when the output signal of the differentiator 23 exceeds a predetermined magnitude threshold, and to output a signal representing a second binary value, for example the value o, when the output signal of the differentiator 23 exceeds the predetermined magnitude threshold or is equal to the predetermined magnitude threshold.

A detection signal representing the detected breathing processes is thus available at the output of the sensor unit 28.

The evaluation unit 25 is adapted to count the user's breathing processes depending on the detection signal provided by the sensor unit 28 and to provide an evaluation signal for a signaling unit 26 depending on a determined number of breathing processes. The evaluation unit 25 has, for example, a counter and/or a shift register and/or a microcontroller.

In the embodiment shown in FIG. 4, the sensor device 6 has a signaling unit 26 as an example. In this example, the signaling unit comprises an LED.

The evaluation unit 25 has, for example, at least a first threshold for a number of breathing processes, and if a count value of the counter exceeds this first threshold, a first evaluation signal is output. The first evaluation signal causes, for example, the light emitting diode of the signaling unit 26 to be activated or switched off, thereby signaling that the first threshold has been reached.

Alternatively, it is possible for the evaluation unit to have multiple thresholds for the number of breathing processes. In this way, for example, a traffic light system can be implemented and the user not only receives the information that the mouth-nose protection is to be changed, but can also receive the information that only a certain number of breathing processes remain until the mouth-nose protection is to be changed.

FIG. 5 shows another embodiment of the differentiator 23. In the example of FIG. 5, the evaluation unit 25 and the signaling unit 26 are not shown. In this case, the decider circuit 24 is designed as a Schmitt trigger. In contrast to the differentiator 23 shown in FIG. 4, the differentiator 23 shown in FIG. 5 includes a feedback capacitance C2 connected in parallel with the feedback resistor R1. This allows additional attenuation of higher frequency components. A positive input of the operational amplifier is referenced to another reference potential, for example to half the supply voltage. For this purpose, for example, a voltage divider is used which has resistors R2 and R3. The reference to the further reference potential results in the output signal U1 having an offset in the operational amplifier of the differentiator. Since the differential quotient can be positive and negative, a differentiator referenced to ground would indicate only positive increases, and negative ones would be below ground.

The decider circuit 24 has a further operational amplifier. The operational amplifier is connected to a further voltage divider and a feedback resistor R10 and operates as an inverting Schmitt trigger. At the same time, the further voltage divider provides a level around which the further operational amplifier operates quasi as a comparator.

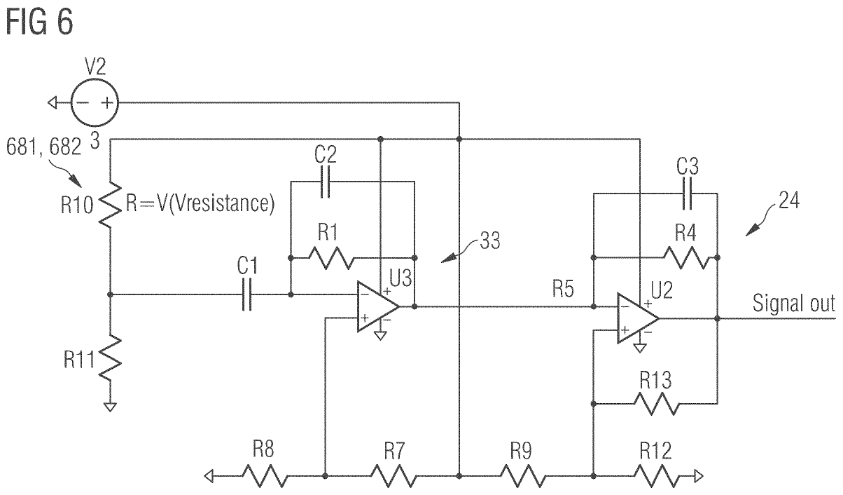

FIG. 6 shows another embodiment of the differentiator 33. Compared to the embodiment shown in FIG. 5, the decider circuit 24 has an operational amplifier which is connected in such a way that it amplifies the received signal (gain>1), forms a Schmitt trigger and low-pass filters the signal.

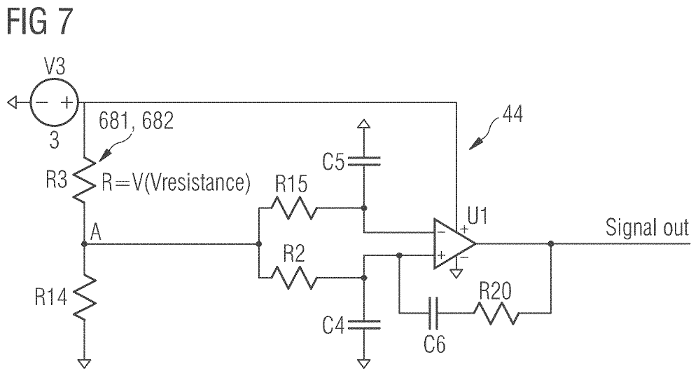

FIG. 7 shows another embodiment of the detection unit of the sensor device 6. FIG. 7 shows an exemplary equivalent circuit diagram of a data slicer 44 which can be used in place of the differentiator 23 and the decider circuit 24 in the sensor device 6 according to FIG. 4. The data slicer 44 is electrically coupled on the input side, for example, to the output of the sensor element 28 and on the output side to the evaluation unit 25.

A data slicer 44 is adapted to equate an input signal of the data slicer 44 with a sliding reference derived from the average DC value of the input signal of the data slicer 44. For example, a low pass filter is used to derive the floating reference.

An input of the data slicer 44 of the sensor device 6 is electrically coupled to an output of the at least one sensor element 28 for receiving the sensor signal. The data slicer 44 is configured to equate the sensor signal to a floating reference, wherein the floating reference is derived or determined from an average DC value of the sensor signal. In the example shown in FIG. 7, the data slicer 44 includes a first low pass filter and a second low pass filter. The low pass filters each include, for example, an RC filter element having different time constants. The large time constant provides the average value, and the small time constant or the smaller capacitance filter is used only to filter the signal so that possible noise or other interfering signals are filtered.

Further, the data slicer 44 has, for example, an operational amplifier connected as a comparator.

The data slicer 44 has the essential advantage that fewer components are required and that the data slicer can be operated with considerably less loss than the differentiator 23, as shown for example in FIG. 5 or 6.

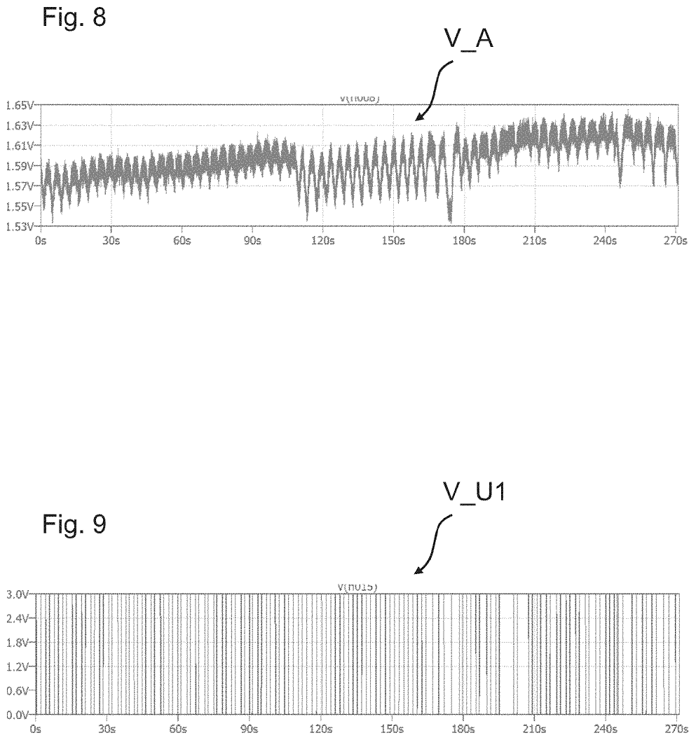

FIG. 8 shows an exemplary curve V_A of the sensor signal over several breathing cycles. The sensor signal is represented by the voltage drop across resistor R3 (compare FIG. 7), which represents, for example, the resistance of the NTC thermistor.

FIG. 9 shows an associated voltage curve V_U1 at the output U1 of the data slicer 44 . It can be seen that the data slicer 44 provides a very precise digital signal representing the respective breathing cycles.

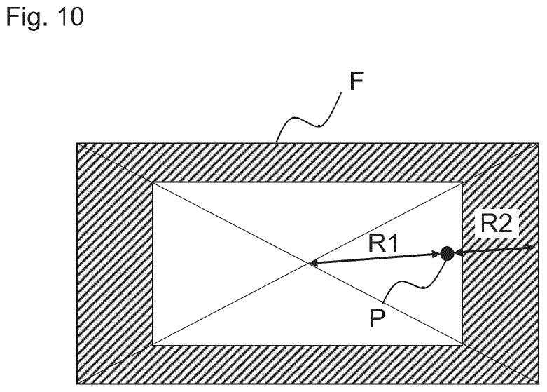

FIG. 10 shows a mouth-nose protection with an exemplary arrangement of the sensor device 6. The mouth-nose protection has a predetermined mask area F. Preferably, at least the sensor element 28 or at least one of the sensor elements 28 is arranged at a position P within the mask area such that a ratio between a first distance R1 from a center of the mask area to the position P of the sensor element and a second distance R2 from a mask edge to the position P of the sensor element has a value less than or equal to four.

The invention is not limited to the embodiments by the description based thereon. Rather, the invention encompasses any new feature as well as any combination of features, which in particular includes any combination of features in the claims, even if this feature or combination itself is not explicitly stated in the claims or embodiments.

1-16. (canceled)

17. A sensor device for arrangement on a mouth-nose protection, the sensor device comprising:
a sensor unit comprising at least one sensor element configured to detect individual breathing processes of a user when the mouth-nose protection with the sensor device is used by a user; and
an evaluation unit configured to:
count the breathing processes of the user depending on a detection signal provided by the sensor unit; and
provide an evaluation signal for a signaling unit depending on a determined number of breathing processes.

18. The sensor device according to claim 17, wherein the at least one sensor element is a temperature sensor element and/or, a humidity sensor element and/or, a pressure sensor element and/or, a carbon dioxide gas sensor element, and/or a sound transducer sensor element.

19. The sensor device according to claim 17, wherein the at least one sensor element is a thermal conductivity sensor element.

20. The sensor device according to claim 17, wherein the sensor device comprises a separating element or a separating element assigned to the sensor device, and wherein the separating element is configured to separate the at least one sensor element from a skin of the user.

21. The sensor device according to claim 20, wherein the separating element comprises at least one opening for a gas or air supply to the at least one sensor element.

22. The sensor device according to claim 17, wherein the sensor device comprises a differentiator, wherein an input of the differentiator is electrically coupled to an output of the at least one sensor element, the input configured to receive a sensor signal of the at least one sensor element.

23. The sensor device according to claim 17, wherein the sensor unit comprises a data separator circuit and an input of the data separator circuit is electrically coupled to an output of the at least one sensor element, the input is configured to receive a sensor signal of the at least one sensor element, wherein the data separator circuit is configured to equate the sensor signal with a floating reference, and wherein the floating reference is derived or determined from an average direct current value of the sensor signal.

24. The sensor device according to claim 17, wherein the at least one sensor element is arranged spatially separated from the evaluation unit, and/or the signaling unit, and/or further components of the sensor unit, and/or a power supply on the mouth-nose protection.

25. The sensor device according to claim 17, wherein the mouth-nose protection has a predetermined mask area and at least the one sensor element is arranged at a position within the mask area such that a ratio between a first distance from a center of the mask area to the position of the sensor element and a second distance from a mask edge to the position of the sensor element has a value smaller than or equal to four.

26. The sensor device according to claim 17, wherein the sensor device comprises at least one connecting device configured to releasably mechanical couple the sensor device or at least a part of the sensor device to the mouth-nose protection.

27. The sensor device according to claim 17, further comprising the signaling unit configured to output an optical and/or acoustic and/or haptic signal depending on the evaluation signal provided by the evaluation unit.

28. The sensor device according to claim 17, wherein the evaluation unit has a wireless interface configured to wirelessly transmit the evaluation signal to a predetermined terminal device.

29. The sensor device according to claim 17, wherein the sensor device comprises a power supply unit and the power supply unit comprises a solid-state accumulator without electrolytes.

30. The sensor device according to claim 17, further comprising a charging unit for charging the accumulator.

31. The sensor device according to claim 3o, wherein the charging unit comprises a passive charging port and/or an energy harvesting unit.

32. A mouth-nose protection device comprising:
the sensor device according to claim 17,
wherein the mouth-nose protection is formed as a face half mask and comprises one or more paper layers and/or one or more fabric layers configured to cover a mouth-nose region of the user.

33. A sensor device for arrangement on a mouth-nose protection, the sensor device comprising:
a sensor unit comprising at least one sensor element configured to detect individual breathing processes of a user when the mouth-nose protection with the sensor device is used by a user;
an evaluation unit configured to:
count the breathing processes of the user depending on a detection signal provided by the sensor unit; and
provide an evaluation signal for a signaling unit depending on a determined number of breathing processes; and
a separating element or a separating element assigned to the sensor device,
wherein the separating element is configured to separate the sensor element from a skin of the user.
